(19) United States
(12) Patent Application Publication
(10) Pub. No.: US 2008/0163319 A1
(43) Pub. Date: Jul. 3, 2008

(54) BROADCAST RECEIVING DEVICE

(75) Inventor: Susumu Tokoshima, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/965,903

(22) Filed: Dec. 28, 2007

(30) Foreign Application Priority Data
Dec. 28, 2006 (JP) 2006-354739

(51) Int. Cl. H04N 7/173

(52) U.S. Cl. 725/110

(57) ABSTRACT

A broadcast receiving device includes a program control storage component, a channel setting component, a program control determination component, a program control execution component, a user determination component and an operation control component. The program control determination component determines whether or not viewing control is enabled for a program corresponding to a channel set by the channel setting component based on program control information stored in the program control storage component. The program control execution component executes the viewing control for the program when the program control determination component determines that the viewing control is enabled for the program. The operation control component disables the viewing control executed by the program control execution component when the user determination component determines that individual identification information identifying a user matches the preset individual identification information.

### CROSS-REFERENCE TO RELATED APPLICATIONS

This application claims priority to Japanese Patent Application No. 2006-354739 filed on Dec. 28, 2006. The entire disclosure of Japanese Patent Application No. 2006-354739 is hereby incorporated herein by reference.

### BACKGROUND OF THE INVENTION

1. Field of the Invention

The present invention generally relates to a broadcast receiving device. More specifically, the present invention relates to a broadcast receiving device for receiving a television broadcast.

2. Background Information

Broadcast receiving devices receive television broadcasts and output the television broadcasts to monitors so that the television broadcasts are visible from outside. The number of channels that can be viewed has been increasing with an increase of popularity of digital broadcasts. There are now more programs that include violence, obscenity, and so forth. Therefore, there is a growing need to control the programs that can be viewed by children, so that the children will not be exposed to such programs.

With some conventional television receiving devices, a remote control is operated to display a TV setup screen, an access code screen, a V-chip setting screen, and an MPAA rating setting screen to set viewing control conditions (see Japanese Laid-Open Patent Application No. 2006-180121, for example). With the conventional television receiving devices, children or others are prevented from setting (or changing the setting of) viewing control conditions by being required to input an access code.

The conventional television receiving devices effectively control programs that can be viewed by children. However, when someone such as a parent views a program that is subject to viewing control, the above-mentioned operation must be performed to disable the viewing control. Also, once the viewing control has been disabled, the above-mentioned operation must be performed again for viewing control to be enabled. Therefore, with the conventional television receiving devices, the required operation was sometimes complicated when someone such as a parent wanted to view a program subject to viewing control.

In view of the above, it will be apparent to those skilled in the art from this disclosure that there exists a need for an improved television receiving device. This invention addresses this need in the art as well as other needs, which will become apparent to those skilled in the art from this disclosure.

### SUMMARY OF THE INVENTION

The present invention was conceived in light of the above-mentioned problems. One object of the present invention is to provide a broadcast receiving device with which viewing control is conveniently disabled.

In accordance with one aspect of the present invention, a broadcast receiving device for receiving a television broadcast includes a program control storage component, a channel setting component, a program control determination component, a program control execution component, a user determination component and an operation control component. The program control storage component is configured to store program control information indicating whether or not viewing control is enabled for each receivable program. The channel setting component is configured to receive operation input and set a channel based on the operation input. The program control determination component is configured to determine whether or not the viewing control is enabled for a program corresponding to the channel set by the channel setting component based on the program control information stored in the program control storage component. The program control execution component is configured to execute the viewing control for the program corresponding to the channel set by the channel setting component when the program control determination component determines that the viewing control is enabled for the program corresponding to the channel set by the channel setting component. The user determination component is configured to receive individual identification information identifying a user when the program control determination component determines that the viewing control is enabled for the program corresponding to the channel set by the channel setting component. The user determination component is configured to determine whether or not the received individual identification information matches preset individual identification information. The operation control component is configured to disable the viewing control executed by the program control execution component when the user determination component determines that the received individual identification information matches the preset individual identification information.

With the broadcast receiving device of the present invention, it is possible to provide a broadcast receiving device with which viewing control is conveniently disabled.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram illustrating a broadcast receiver in accordance with one embodiment of the present invention;

FIG. 2 is a plan view of a remote control of the broadcast receiver illustrated in FIG. 1;

FIG. 3 is a block diagram illustrating a functional configuration of the broadcast receiver illustrated in FIG. 1;

FIG. 4 is a diagram illustrating a viewing control table;

FIG. 5 is a flowchart illustrating an operation of the broadcast receiver illustrated in FIG. 1;

FIG. 6 is a flowchart illustrating a viewing control enablement processing of the operation illustrated in FIG. 5;

FIG. 7 is a flowchart illustrating a viewing control disablement processing of the operation illustrated in FIG. 5;

FIG. 8 is a flowchart illustrating a temporary disablement processing of the operation illustrated in FIG. 5;

FIG. 9 is a flowchart illustrating a temporary disablement termination processing of the operation illustrated in FIG. 5;

FIG. 10A is a screen shot displayed when a viewing control is enabled; and

FIG. 10B is a screen shot displayed when the viewing control is disabled.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

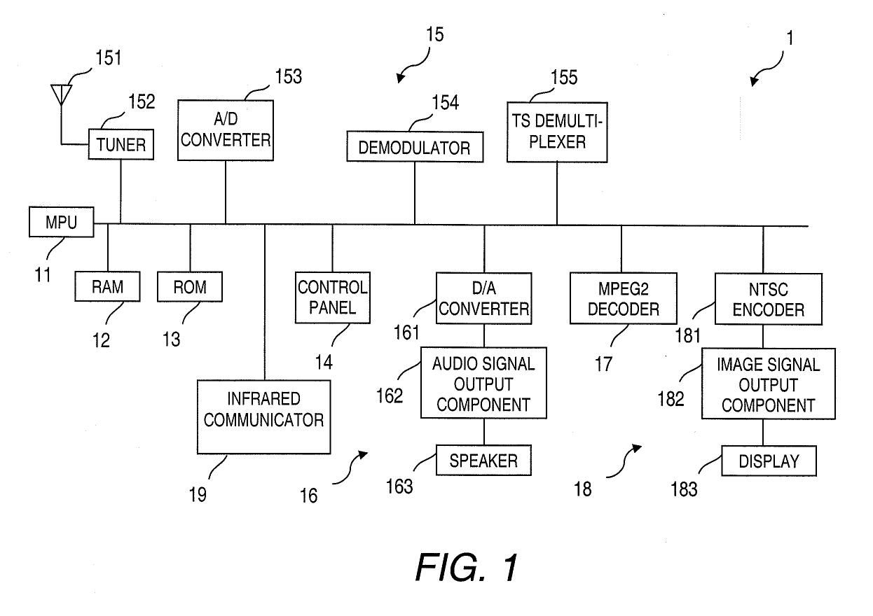

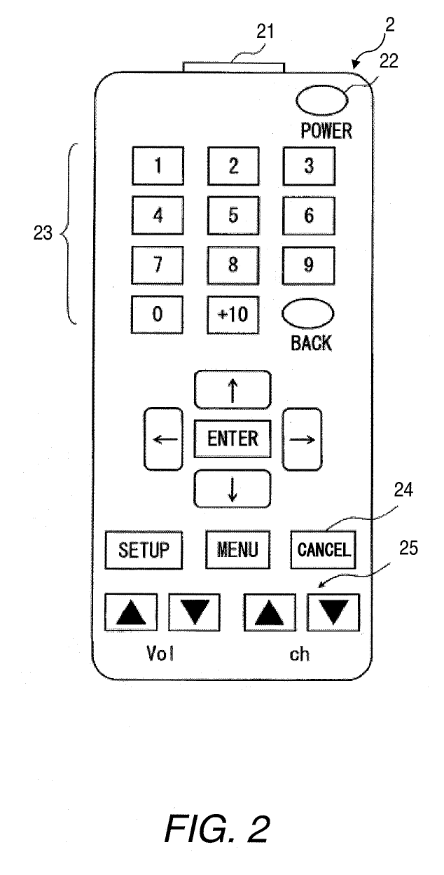

FIG. 1 is a block diagram illustrating a digital broadcast receiver 1. The digital broadcast receiver 1 (e.g., broadcast receiving device) is communicably connected to a remote controller 2 (hereinafter referred to as “remote”) shown in FIG. 2 via infrared communication.

The digital broadcast receiver 1 receives an operation input from a user via the remote 2. The digital broadcast receiver 1 receives television broadcasts and outputs one of the television broadcasts to a display 183. The digital broadcast receiver 1 includes an MPU (Micro Processing Unit) 11, a RAM (Random Access Memory) 12, a ROM (Read Only Memory) 13, a control panel 14, a reception component 15, an audio output component 16, an MPEG-2 (Motion Picture Experts Group) decoder 17, an image output component 18 and an infrared communicator 19.

The MPU 11 controls an operation of the entire digital broadcast receiver 1. The RAM 12 readably and writably stores information such as audio information and video information. The ROM 13 stores a control program for operating the MPU 11, for example.

The control panel 14 is used to perform various operations, such as turning the power on and off, and changing the channel. The reception component 15 receives and demodulates television broadcasts. The reception component 15 includes an antenna 151, a tuner 152, an A/D converter 153, a demodulator 154, and a TS demultiplexer 155.

The antenna 151 receives television broadcast waves. The tuner 152 tunes in a preset channel from the television broadcast waves received by the antenna 151. The A/D converter 153 converts an analog output signal of the tuner 152 into a digital signal. The demodulator 154 demodulates output information from the A/D converter 153. The TS demultiplexer 155 separates the output information demodulated by the demodulator 154 by type, and outputs audio information and video information.

The audio output component 16 outputs the audio corresponding to the television broadcast received by the reception component 15. The audio output component 16 includes a D/A converter 161, an audio signal output component 162 and a speaker 163. The D/A converter 161 converts the audio information outputted from the TS demultiplexer 155 (digital information) into an analog audio signal. The audio signal output component 162 outputs the analog audio signal to the speaker 163. The speaker 163 outputs audio corresponding to the analog audio signal.

The MPEG 2 decoder 17 decodes the video information outputted from the TS demultiplexer 155 into pre-compression video information.

The image output component 18 outputs the video information decoded by the MPEG2 decoder 17. The image output component 18 includes an NTSC (National Television Standards Committee) encoder 181, an image signal output component 182 and a display 183 (e.g., monitor). The NTSC encoder 181 converts the video information decoded by the MPEG2 decoder 17 into an NTSC-format television signal. The image signal output component 182 outputs the NTSC-format television signal to the display 183. The display 183 is a display device such as an LCD (Liquid Crystal Display), PDP (Plasma Display Panel), or the like. The display 183 displays video corresponding to the NTSC-format television signal outputted from the image signal output component 182.

The infrared communicator 19 is used to perform various operations from the remote 2, such as turning the power on and off, changing the channel, and changing settings of the digital broadcast receiver 1 (such as viewing control settings).

The digital broadcast receiver 1 receives the television broadcasts as follows. First, a transmitted digital broadcast wave is received by the antenna 151. When the control panel 14 is used to tune in a channel, switching of a transponder or a channel received by the tuner 152 is performed. The received digital broadcast wave is converted into digital information by the A/D converter 153, and demodulated by the demodulator 154.

The digital broadcast wave is transmitted from a transmitting side (transmitting station) as a TS (Transport Stream) packet. The TS packet includes the video information, the audio information, control information including viewing control table information, and so forth. The viewing control table information further includes a viewing control table having viewing control conditions for viewing control. The viewing control is also called a parental control, which allows a parent to limit what a child can see or do. The video information, the audio information and the control information are separated and outputted by the TS demultiplexer 155. Then, the video information, the audio information and the control information are stored in the RAM 12. The audio information is read out from the RAM 12, and is converted into an analog audio signal by the D/A converter 161. Then, audio is outputted from the speaker 163 via the audio signal output component 162.

Also, the video information is read out from the RAM 12, and is decoded into pre-compression video information by the MPEG2 decoder 17. Then, the pre-compression video information is converted into an NTSC-format television signal by the NTSC encoder 181. Then, a video image is displayed on the display 183 via the image signal output component 182.

FIG. 2 is a plan view of the remote 2. The remote 2 receives operation input from a user. The remote 2 produces an infrared signal corresponding to the operation input. Then, the remote 2 outputs the infrared signal to the digital broadcast receiver 1. The remote 2 includes an infrared signal output component 21, a power key 22, a number pad 23, a cancel key 24 and channel keys 25. The infrared signal output component 21 produces an operation signal corresponding to a key pressed by the user. The infrared signal output component 21 converts the signal into the infrared signal. Then, the infrared signal output component 21 transmits the signal to the digital broadcast receiver 1.

The power key 22 is pressed to turn the power on and off to the digital broadcast receiver 1. Also, the power key 22 is pressed to enable a disabled viewing control (that is, return the viewing control to an initial state). The number pad 23 includes keys corresponding to the numerals 0 to 9. The number pad 23 is used to input channel numbers, identification numbers, and so forth. The cancel key 24 (e.g., specific key) is pressed to disable viewing control or to enable the disabled viewing control. The channel keys 25 are pressed to change the channel in a preset order.

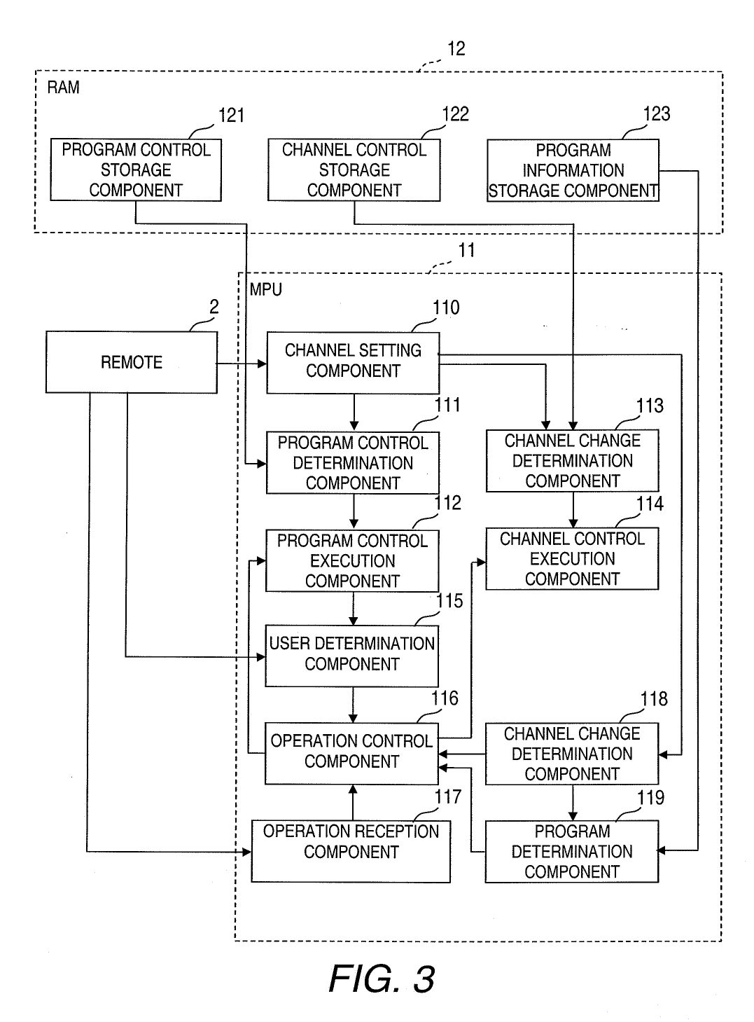

FIG. 3 is a block diagram illustrating a functional configuration of the digital broadcast receiver 1. The MPU 11 functionally includes a channel setting component 110, a program control determination component 111, a program control execution component 112, a channel change determination component 113, a channel control execution component 114, a user determination component 115, a operation control component 116, a operation reception component 117, a channel change determination component 118, and a program determination component 119. The RAM 12 functionally includes a program control storage component 121, a channel control storage component 122, and a program information storage component 123.

The MPU 11 reads and executes a control program that has been pre-stored in the ROM 13, etc., shown in FIG. 1. Then, the MPU 11 functions as the channel setting component 110, the program control determination component 111, the program control execution component 112, the channel change determination component 113, the channel control execution component 114, the user determination component 115, the operation control component 116, the operation reception component 117, the channel change determination component 118, the program determination component 119, or another such functional component. Also, the MPU 11 causes the RAM 12 to function as the program control storage component 121, the channel control storage component 122, the program information storage component 123, or another such functional component.

Data stored in the RAM 12 and ROM 13 can be stored on a removable recording medium such as a hard disk, optical disk, flexible disk, CD (Compact Disk), DVD (Digital Versatile Disk), semiconductor memory, or the like. In this case, the data can be readable by a hard disk drive, optical disk drive, flexible disk drive, silicon disk drive, cassette medium reader, or other such driver.

The program control storage component 121 stores program control information for each receivable program. The program control information is information setting whether or not the viewing control is to be performed. In other words, the program control information indicates whether or not the viewing control is enabled for each receivable program. The program control information is set ahead of time, and is stored in the program control storage component 121 according to program identification information included in an event information table (hereinafter referred to as EIT).

A rating region table (hereinafter referred to as RRT) is received via the reception component 15 shown in FIG. 1. The viewing control table (hereinafter referred to as a rating table) included in the TS packet is updated based on the received RRT, and is stored in the ROM 13, etc. The rating table is a table in which the viewing control conditions are specified. Specifically, the viewing control conditions are preset according to positions in a column direction and positions in a row direction.

Also, program viewing control information is acquired via the reception component. The program viewing control information is included in the EIT as a content advisory descriptor (hereinafter referred to as CAD), and specifies the viewing control conditions for each program. The CAD is information included in the EIT, and specifies the viewing control conditions as column number information indicating the position in the column direction of the rating table and row number information indicating the position in the row direction.

The user sets whether or not to execute the viewing control specified by the CAD (that is, whether or not to block viewing) by referring to the rating table via the remote 2, and thereby produces the program control information, which is setting information indicating whether or not the viewing of a program is to be blocked.

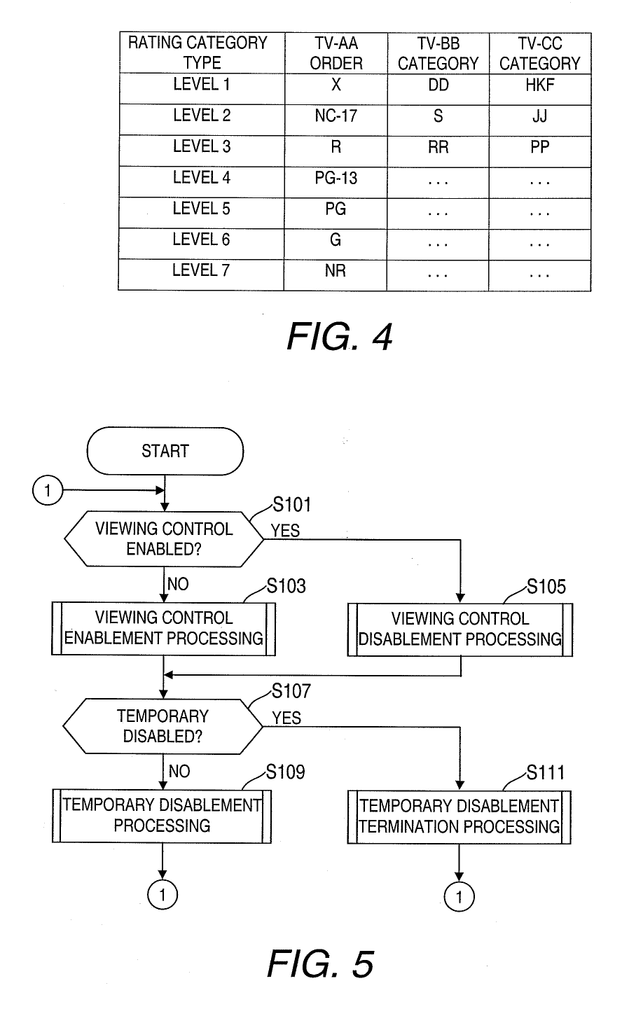

FIG. 4 is an example of the rating table. As shown in FIG. 4, for example, the first column in the rating table is order-type viewing control conditions whose rating category name is set to “TV-AA”. The viewing control conditions “TV-AA” include ratings according to MPAA (Motion Picture Association of America) standards. Specifically, beginning with the first row in the first column, the viewing control conditions “TV-AA” includes following viewing control conditions: X, NC-17, R, PG-13, PG, G, and NR. The order-type viewing control conditions include the viewing control conditions ranked in the order of rating levels from the lowest rating to the highest rating as the row number increases. In other words, the order-type viewing control conditions include the viewing control conditions so that the viewing control becomes less restrictive as the row number increases.

The X in the first row is a rating that is an old version of the NC-17. The NC-17 (No Children under 17, or No One 17 And Under Admitted) in the second row means that no one under 18 years old (17 years or under) is admitted to enjoy the viewing. The R (Restricted) in the third row means that an accompanying a parent or a guardian is required for children under 17 (16 years or under). The PG-13 (Parents strongly cautioned) in the fourth row means that a parent or a guardian must exercise caution over viewing by a child under 13 years old (12 years or under).

The PG (Parental Guidance suggested) in the fifth row means that it is recommended that a parent or a guardian check the content before it is viewed by a child. The G (General audiences) in the sixth row means the work is suitable for all ages. The NR (Not Rated) in the seventh row means that there is no viewing control.

The channel control storage component 122 stores channel control information for each receivable channel. The channel control information is information setting whether or not the viewing control is to be performed. In other words, the channel control information indicates whether or not the viewing control is enabled for each receivable channel. More specifically, for example, the user sets whether or not perform the viewing control via the remote 2 for each receivable channel, and thereby produces the channel control information. The channel control information is stored in the channel control storage component 122 according to channel identification information (such as channel number information), which identifies a channel.

The program information storage component 123 stores schedule information for each program. The schedule information indicates a start time and an end time for each program. Here, the schedule information for each program is included in the EIT. The EIT is acquired ahead of time via the reception component 15 shown in FIG. 1. The schedule information included in the EIT is stored in the program information storage component 123 according to the program identification information. The program identification information is information identifying the programs included in the EIT.

When an operation signal corresponding to the number pad 23 or the channel keys 25 has been received, the channel setting component 110 sets or changes the received channel based on the received operation signal (that is, the transponder received by the tuner 152 of the reception component 15 is switched).

When the channel has been set (or changed) by the channel setting component 110, the program control determination component 111 determines whether or not the viewing control is enabled for the program corresponding to the channel based on the program control information stored in the program control storage component 121.

More specifically, the program control determination component 111 acquires from the EIT the program identification information about a program being received on the channel set by the channel setting component 110. Then, the program control determination component 111 reads the program control information corresponding to the acquired program identification information. Furthermore, the program control determination component 111 determines whether or not the viewing control is enabled based on the program control information. Also, the program control determination component 111 acquires from the EIT the end time for the program being received on the channel set by the channel setting component 110. Then, the program control determination component 111 determines whether or not the end time has been reached for the program being received. If the program control determination component 111 determines that the end time has been reached, then the program control determination component 111 acquires from the EIT the program identification information about the program being received on the channel set by the channel setting component 110. Furthermore, the program control determination component 111 reads the program control information corresponding to the acquired program identification information. Then, the program control determination component 111 determines whether or not the viewing control is enabled based on the program control information.

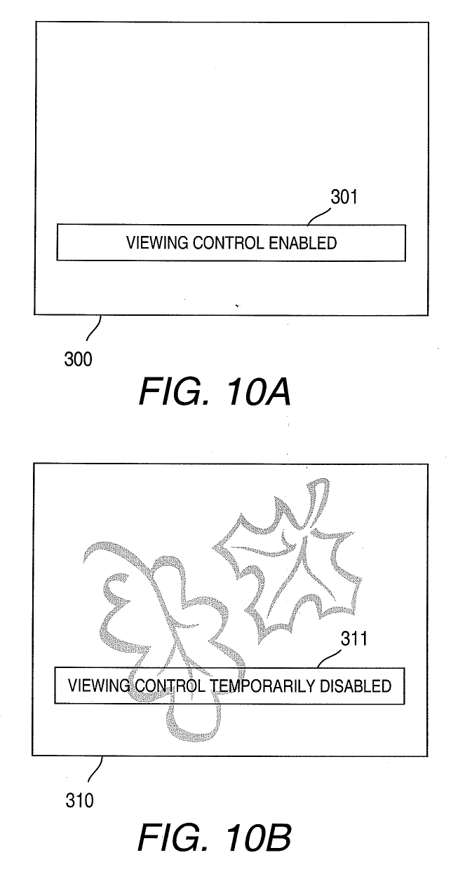

The program control execution component 112 blocks the viewing of the program corresponding to the channel (that is, the program being received on the channel) when the program control determination component 111 determines that the viewing control has been enabled. In other words, the program control execution component 112 executes the viewing control for the program. The program control execution component 112 uses OSD or the like to display a notice that viewing is blocked on the display 183, as shown in FIG. 10A. For example, text information reading “Viewing control enabled” is displayed.

the channel change determination component 113 determines whether or not the viewing control is enabled for the channel set by the channel setting component 110 based on the channel control information stored in the channel control storage component 122.

More specifically, the channel change determination component 113 reads from the channel control storage component 122 the channel control information corresponding to the channel identification information of the channel set by the channel setting component 110. Then, the channel change determination component 113 determines whether or not the viewing control is enabled based on the channel control information.

The channel control execution component 114 blocks the viewing of the channel set by the channel setting component 110 when the channel change determination component 113 determines that the viewing control has been enabled. In other words, the channel control execution component 114 executes the viewing control for the channel. Then, the channel control execution component 114 uses OSD or the like to display a notice that viewing is blocked on the display 183 for a preset length of time (such as 10 seconds). For example, text information reading “Viewing control enabled” is displayed.

The user determination component 115 determines whether or not an operation signal corresponding to the cancel key 24 has been received when at least one of the program control determination component 111 and the channel change determination component 113 determines that the viewing control is enabled. If the user determination component 115 determines that the operation signal corresponding to the cancel key 24 has been received, then the user determination component 115 requires and receives identification number information via the number pad 23. Furthermore, the user determination component 115 determines whether or not the received identification number information matches preset identification number information. A four-digit number, for example, is preset as the preset identification number information.

The operation control component 116 disables the operation of the program control execution component 112 and the channel control execution component 114 when the user determination component 115 determines that there is a match. In other words, the operation control component 116 disables the viewing control executed by at least one of the program control execution component 112 and the channel control execution component 114. As a result, the operation of blocking viewing is disabled, which means that viewing is possible. Then, the operation control component 116 uses OSD or the like to display a notice that the operation of blocking viewing has been disabled on the display 183 for a preset length of time (such as 10 seconds). For example, text information reading “Viewing control temporarily disabled” is displayed, as shown in FIG. 10B.

The operation control component 116 enables the operation of the program control execution component 112 and the channel control execution component 114 when the operation reception component 117 determines that an operation signal corresponding to the cancel key 24 or the power key 22 has been received, or when the channel change determination component 118 determines that another channel has been set, or when the program determination component 119 determines that the end time has been reached for the program. Then, the operation of blocking viewing by the program control execution component 112 and the channel control execution component 114 becomes possible. Furthermore, the operation control component 116 uses OSD or the like to display a notice that the viewing is blocked on the display 183 for a preset length of time (such as 10 seconds). For example, text information reading “Viewing control enabled” is displayed, as shown in FIG. 10A.

The operation reception component 117 determines whether or not an operation signal corresponding to the cancel key 24 or the power key 22 has been received when the operation of the program control execution component 112 and the channel control execution component 114 has been disabled by the operation control component 116.

The channel change determination component 118 determines whether or not another channel has been set by the channel setting component 110 (that is, whether or not the channel has been changed) when the operation of the program control execution component 112 and the channel control execution component 114 has been disabled by the operation control component 116.

The program determination component 119 determines whether or not the end time has been reached for a program for which the operation of the program control execution component 112 and the channel control execution component 114 has been disabled when the operation of the program control execution component 112 and the channel control execution component 114 has been disabled by the operation control component 116.

More specifically, if the viewing of a program has been blocked by the program control execution component 112, then the program determination component 119 reads from the program information storage component 123 the end time corresponding to the program identification information acquired from the EIT by the program control determination component 111. The program determination component 119 further determines whether or not the end time has been reached.

Also, if the viewing of a program has been blocked by the channel control execution component 114, then the program determination component 119 acquires the program identification information from the EIT via the reception component 15. The acquired program identification information is information corresponding to the program being received on the channel for which the channel change determination component 113 determines that the viewing control is enabled. The program determination component 119 reads the end time corresponding to the acquired program identification information from the program information storage component 123. Then, the program determination component 119 determines whether or not the end time has been reached.

FIG. 5 is a flowchart illustrating an operation of the digital broadcast receiver 1. The program control information has been set ahead of time and stored in the program control storage component 121. The channel control information has been set ahead of time and stored in the channel control storage component 122.

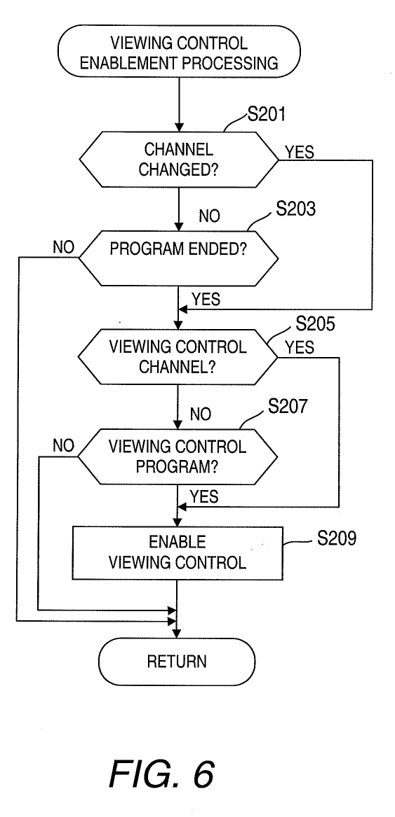

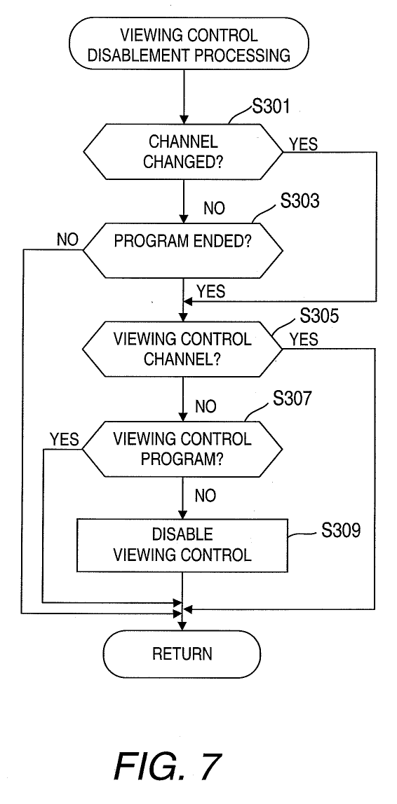

First, the user determination component 115 determines whether or not the viewing control is enabled by at least one of the program control determination component 111 and the channel change determination component 113 (S101). If the user determination component 115 determines that the viewing control is disabled (No in S101), then the viewing control enablement processing shown in FIG. 6 is executed (S103) and the processing proceeds to step S107. If the user determination component 115 determines that the viewing control is enabled (Yes in S101), then the viewing control disablement processing shown in FIG. 7 is executed (S105) and the processing proceeds to step S107.

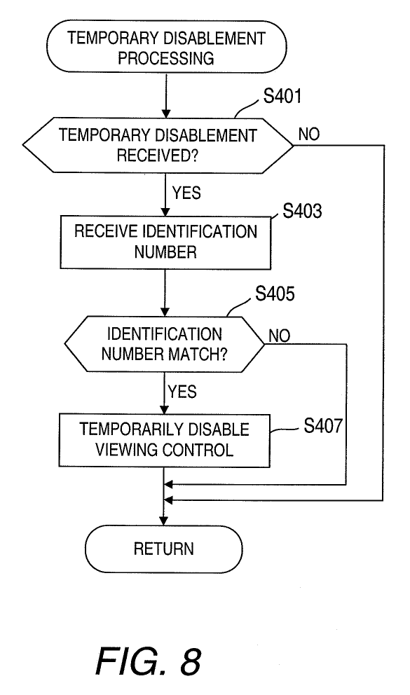

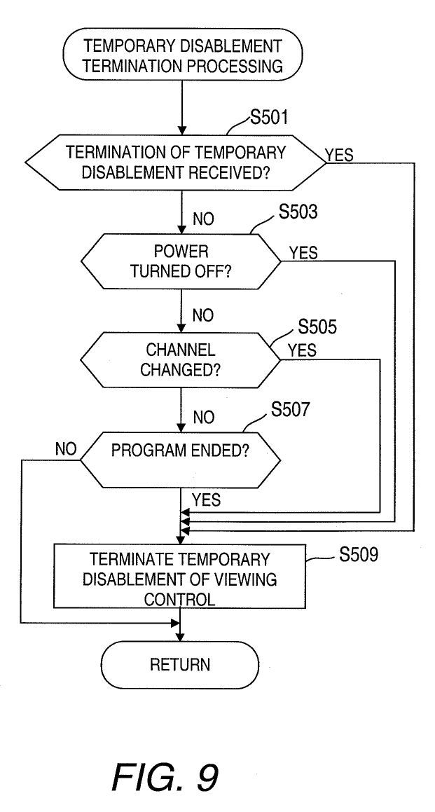

If the processing is concluded in step S103 or S105, then it is determined whether or not the operation of the program control execution component 112 and the channel control execution component 114 has been disabled by the operation control component 116 (S107). Here, a state in which the operation of the program control execution component 112 and the channel control execution component 114 has been disabled by the operation control component 116 is called “temporary disablement in progress”. If it is determined that temporary disablement is not in progress (No in S107), then the temporary disablement processing shown in FIG. 8 is executed (S109). Then, the processing returns to step S101, and the processing from step S101 is repeated. If it is determined that temporary disablement is in progress (Yes in S107), then the temporary disablement termination processing shown in FIG. 9 is executed (S111). Then, the processing returns to step S101, and the processing from step S101 is repeated.

FIG. 6 is a flowchart illustrating the viewing control enablement processing executed in step S103 shown in FIG. 5. First, it is determined whether or not the received channel has been changed by the channel setting component 110 (S201). If it is determined that the channel has been changed (Yes in S201), then the processing proceeds to step S205. If it is determined that the channel has not been changed (No in S201), then the program control determination component 111 determines whether or not the program being received has ended (S203). If the program control determination component 111 determines that the program being received has not ended (No in S203), then the processing is returned to step S107.

If the answer is Yes in step S201 or Yes in step S203, then the channel change determination component 113 determines whether or not the viewing control enabled for the channel set in step S201 (S205). If the channel change determination component 113 determines that the viewing control is enabled (Yes in S205), then the processing proceeds to step S209. If the channel change determination component 113 determines that the viewing control is disabled (No in S205), then the program control determination component 111 further determines whether or not the viewing control is enabled for the program being received (S207). If the program control determination component 111 determines that the viewing control is disabled (No in S207), then the processing is returned to step S107. If the program control determination component 111 determines that the viewing control is enabled (Yes in S207), or if the answer is Yes in step S205, then the viewing control is executed by the program control execution component 112 or the channel control execution component 114 (that is, viewing of the program is blocked) (S209). Then, the processing is returned to step S107.

FIG. 7 is a flowchart illustrating a viewing control disablement processing executed in step S105 shown in FIG. 5. First, it is determined whether or not the received channel has been changed by the channel setting component 110 (S301). If it is determined that the channel has been changed (Yes in S301), then the processing proceeds to step S305. If it is determined that the channel has not been changed (No in S301), then the program control determination component 111 determines whether or not the program being received has ended (S303). If the program control determination component 111 determines that the program being received has not ended (No in S303), then the processing is returned to step S107.

If the answer is Yes in step S301 or Yes in step S303, then the channel change determination component 113 determines whether or not the viewing control is enabled for the channel set in step S301 (S305). If the channel change determination component 113 determines that the viewing control is enabled (Yes in S305), then the processing is returned to step S107. If the channel change determination component 113 determines that the viewing control is disabled (No in S305), then the program control determination component 111 determines whether or not the viewing control is enabled for the program being received (S307). If the program control determination component 111 determines that the viewing control is enabled (Yes in S307), then the processing is returned to step S107. If the program control determination component 111 determines that the viewing control is disabled (No in S307), then the viewing control by the program control execution component 112 or the channel control execution component 114 is disabled (that is, blocking of the viewing of the program is disabled) (S309). Then, the processing is returned to step S107.

FIG. 8 is a flowchart illustrating a temporary disablement processing executed in step S109 shown FIG. 5. First, the user determination component 115 determines whether or not an operation signal corresponding to the cancel key 24 has been received (S401). If the user determination component 115 determines that the operation signal corresponding to the cancel key 24 has not been received (No in S401), then the processing is returned to step S101. If the user determination component 115 determines that the operation signal corresponding to the cancel key 24 has been received (Yes in S401), then the user determination component 115 requests and receives the identification number information via the number pad 23 (S403). Then, the user determination component 115 determines whether or not the identification number received in step S403 matches the preset identification number information (S405). If the user determination component 115 determines that there is no match (No in S405), then the processing is returned to step S101. If the user determination component 115 determines that there is a match (Yes in S405), then the operation of the program control execution component 112 and the channel control execution component 114 is disabled by the operation control component 116 (that is, the viewing control is temporarily disabled) (S407). Then, the processing is returned to step S101.

FIG. 9 is a flowchart illustrating a temporary disablement termination processing executed in step S111 shown in FIG. 5. First, the operation reception component 117 determines whether or not an operation signal corresponding to the cancel key 24 has been received (S501). If the operation reception component 117 determines that the operation signal corresponding to the cancel key 24 has been received (Yes in S501), then the processing proceeds to step S509. If the operation reception component 117 determines that the operation signal corresponding to the cancel key 24 has not been received (No in S501), then the operation reception component 117 determines whether or not an operation signal corresponding to the power key 22 has been received (S503).

If the operation reception component 117 determines that the operation signal corresponding to the power key 22 has been received (Yes in S503), then the processing proceeds to step S509. If the operation reception component 117 determines that the operation signal corresponding to the power key 22 has not been received (No in S503), then the channel change determination component 118 determines whether or not the channel has been changed by the channel setting component 110 (S505). If the channel change determination component 118 determines that the channel has been changed (Yes in S505), then the processing proceeds to step S509. If the channel change determination component 118 determines that the channel has not been changed (No in S505), then the program determination component 119 determines whether or not the end time of the program has been reached (S507). If the program determination component 119 determines that the end time of the program has not been reached (No in S507), then the processing is returned to step S101. If the answer is Yes in step S501, Yes in step S503 or Yes in step S505, or if the program determination component 119 determines that the end time of the program has been reached (Yes in S507), then the operation of the program control execution component 112 and the channel control execution component 114 is enabled by the operation control component 116 (that is, the operation of blocking viewing is made possible) (S509). Then, the processing is returned to step S101.

FIGS. 10A and 10B are screen shots displayed on the display 183 by the program control execution component 112, the channel control execution component 114, and the operation control component 116. FIG. 10A is a screen shot of the viewing control screen displayed when the viewing control is enabled (or restarted) in step S209 in the flowchart shown in FIG. 6 and in step S509 in the flowchart shown in FIG. 9. FIG. 10B is a screen shot of the temporary disablement screen displayed when the viewing control is temporarily disabled in step S407 in the flowchart shown in FIG. 8.

A guidance display component 301 is displayed on the viewing control screen 300 shown in FIG. 10A. The guidance display component 301 displays guidance information indicating that the operation of blocking viewing is enabled. Specifically, text information reading “Viewing control enabled” is displayed in the guidance display component 301. A guidance display component 311 is displayed on the temporary disablement screen 310 shown in FIG. 10B. The guidance display component 311 displays guidance information indicating that the operation of blocking viewing is disabled. Specifically, text information reading “Viewing control temporarily disabled”) is displayed in the guidance display component 311.

With the digital broadcast receiver 1, the program control information is stored for each receivable program in the program control storage component 121. The program control information is information setting whether or not the viewing control is enabled. When an operation signal corresponding to the number pad 23 or the channel keys 25 is received, the channel to be received is set based on the received operation signal. When a channel has been set, it is determined, based on the program control information, whether or not the viewing control has been enabled for a program corresponding to the channel. If it is determined that the viewing control is enabled, then the viewing of the program is blocked. Then, the individual identification information, such as the identification number information, is received via the number pad 23. The individual identification information is information that identifies a user. Furthermore, it is determined whether or not the received individual identification information matches the preset individual identification information. If it is determined that there is a match, then the operation of blocking the viewing of a program is disabled. As a result, the viewing control is conveniently disabled.

Specifically, the individual identification information is received via the number pad 23. Then, it is determined whether or not the received individual identification information matches the preset individual identification information. If it is determined that there is a match, then the operation of blocking the viewing of a program is disabled. In other words, the operation of blocking the viewing of the program is disabled (that is, the program can be viewed) without changing the program control information stored in the program control storage component 121. Thus, the viewing control is conveniently disabled.

Also, the channel control information is stored in the channel control storage component 122 for each receivable channel. The channel control information is information setting whether or not the viewing control is enabled. When an operation signal corresponding to the number pad 23 or the channel keys 25 is received, the channel to be received is set. When a channel has been set, it is determined, based on the channel control information, whether or not the viewing control is enabled for the channel. If it is determined that the viewing control is enabled, then the viewing of the channel is blocked. Then, the individual identification information, such as identification number information, is received via the number pad 23. The individual identification information is information that identifies a user. Furthermore, it is determined whether or not the received individual identification information matches the preset individual identification information. If it is determined that there is a match, then the operation of blocking the viewing of a program is disabled. As a result, the viewing control is conveniently disabled.

Specifically, the individual identification information is received via the number pad 23. Then, it is determined whether or not the received individual identification information matches the preset individual identification information. If it is determined that there is a match, then the operation of blocking the viewing of a program is disabled. In other words, the operation of blocking the viewing of the program is disabled (that is, a program can be viewed) without changing the channel control information stored in the channel control storage component 122. Thus, the viewing control is conveniently disabled.

Furthermore, the identification number information is used as the individual identification information. Thus, whether or not there is a match with the preset individual identification information can be determined easily. Therefore, the viewing control can be conveniently disabled.

In addition, it is determined whether or not an operation signal corresponding to a specific preset key out of the plurality of keys (e.g., the cancel key 24) has been received from the remote 2. Furthermore, the identification number information is received when it has been determined that the operation signal corresponding to the specific key has been received. Thus, the viewing control can be conveniently disabled.

Specifically, when the viewing control is disabled, an identification number is inputted after pressing the specific key on the remote 2 (e.g., the cancel key 24). Therefore, the viewing control can be conveniently disabled.

Also, when the operation of blocking the viewing of a program is being disabled, it is determined whether or not the operation signal corresponding to the specific key (e.g., the cancel key 24) has been received. If it is determined that the operation signal corresponding to the specific key has been received, then the operation of blocking the viewing of the program is enabled (that is, the viewing of the program is blocked). Therefore, disabled viewing control can be conveniently enabled.

Specifically, when the disabled viewing control is to be enabled, a specific key on the remote 2 is pressed (e.g., the cancel key 24). Thus, the disabled viewing control can be conveniently enabled. For example, even if someone such as a child enters a room in which the digital broadcast receiver 1 is installed during the viewing of a program subject to the viewing control, the disabled viewing control can be enabled by a simple operation (namely, pressing the specific key).

Furthermore, when the operation of blocking the viewing of the program is being disabled, it is determined whether or not another channel has been set. If it is determined that another channel has been set, then the operation of blocking the viewing of the program is enabled (that is, the viewing of the program is blocked). Therefore, disabled viewing control can be conveniently enabled.

Specifically, when the operation of blocking the viewing of a program received on a channel is being disabled, if another channel has been set (that is, if the channel has been changed), then the operation of blocking the viewing of the program received on the channel is enabled (that is, the viewing of the program is blocked). Therefore, the disabled viewing control can be conveniently enabled.

For example, even if someone such as a child enters a room in which the digital broadcast receiver 1 is installed during the viewing of a program subject to the viewing control, the disabled viewing control can be enabled by a simple operation (namely, changing the channel).

In addition, when the schedule information for each program is stored in the program information storage component 123, and the operation of blocking the viewing of a program is being disabled, it is determined, based on the program information storage component 123, whether or not the end time has been reached for the program for which the operation of blocking viewing is being disabled. If it is determined that the end time of the program has been reached, then the operation of blocking the viewing of the program is enabled. Therefore, the disabled viewing control can be conveniently enabled.

Specifically, the operation of blocking the viewing of a program is enabled when it is determined that the end time has been reached for the program for which the operation of blocking viewing is being disabled. Thus, even if the viewer should for some reason fail to enable the disabled viewing control, the disabled viewing control can be conveniently enabled.

For example, even if a parent or other viewer should have to leave suddenly while the operation of blocking the viewing of a program is being disabled, if it is determined that the end time has been reached for the program for which the operation of blocking viewing is being disabled, then the operation of blocking program viewing will be enabled. Thus, the disabled viewing control can be conveniently enabled.

The broadcast receiver 1 can be any type of broadcast receiving device that receives television broadcasts and outputs the television broadcasts to the display 183 so that the television broadcasts are visible from outside. For instance, the broadcast receiving device can be a device that receives analog broadcasts or both analog and digital broadcasts. However, the broadcast receiver 1 has a function for acquiring the program viewing control information corresponding to a CAD and the viewing control table information corresponding to the RRT.

The display 183 can be configured as a device that is separate from the digital broadcast receiver 1. For example, the display 183 can be a monitor provided to a personal computer or the like.

At least one of the channel setting component 110, the user determination component 115, and the operation reception component 117 can receive the operation input from the user via the control panel 14 instead of the remote 2.

The user determination component 115 can use fingerprint information, pulse information, retina information, or other such biometric information as the individual identification information. In this case, a personal identification can be performed even more reliably.

In this embodiment, a case was described in which the user determination component 115 receives the identification number information via the number pad 23 when an operation signal corresponding to the cancel key 24 is received. The user determination component 115 can receive the identification number information via the number pad 23 for just a specific length of time (such as 10 seconds) after the viewing control is set to be enabled by at least one of the program control determination component 111 and the channel change determination component 113 (that is, after viewing control begins). In this case, there is no need to press the cancel key 24 to perform temporary disablement. Thus, the viewing control can be conveniently disabled.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A broadcast receiving device for receiving a television broadcast, comprising:
a program control storage component configured to store program control information indicating whether or not viewing control is enabled for each receivable program;
a channel setting component configured to receive operation input and set a channel based on the operation input;
a program control determination component configured to determine whether or not the viewing control is enabled for a program corresponding to the channel set by the channel setting component based on the program control information stored in the program control storage component;
a program control execution component configured to execute the viewing control for the program corresponding to the channel set by the channel setting component when the program control determination component determines that the viewing control is enabled for the program corresponding to the channel set by the channel setting component;
a user determination component configured to receive individual identification information identifying a user when the program control determination component determines that the viewing control is enabled for the program corresponding to the channel set by the channel setting component, and determine whether or not the received individual identification information matches preset individual identification information; and
an operation control component configured to disable the viewing control executed by the program control execution component when the user determination component determines that the received individual identification information matches the preset individual identification information.

2. The broadcast receiving device according to claim 1, further comprising
a channel control storage component configured to store channel control information indicating whether or not the viewing control is enabled for each receivable channel;
a channel control determination component configured to determine whether or not the viewing control is enabled for the channel set by the channel setting component based on the channel control information stored in the channel control storage component; and
a channel control execution component configured to execute the viewing control for the channel set by the channel setting component when the channel control determination component determines that the viewing control is enabled for the channel set by the channel setting component,
the user determination component being further configured to receive the individual identification information when the channel control determination component determines that the viewing control is enabled for the channel set by the channel setting component, and determine whether or not the received individual identification information matches the preset individual identification information, and
the operation control component being further configured to disable the viewing control executed by the channel control execution component when the user determination component determines that the received individual identification information matches the preset individual identification information.

3. The broadcast receiving device according to claim 2, wherein
the user determination component is further configured to receive identification number information as the individual identification information.

4. The broadcast receiving device according to claim 3, wherein
the user determination component is further configured to determine whether or not an operation signal corresponding to a specific key out of a plurality of keys of a remote control has been received from the remote control, and receive the identification number information when the user determination component determines that the operation signal corresponding to the specific key has been received.

5. The broadcast receiving device according to claim 4, further comprising
an operation reception component configured to determine whether or not the operation signal corresponding to the specific key has been received from the remote control when the viewing control executed by one of the program control execution component and the channel control execution component has been disabled by the operation control component,
the operation control component being further configured to enable the viewing control executed by one of the program control execution component and the channel control execution component when the operation reception component determines that the operation signal corresponding to the specific key has been received.

6. The broadcast receiving device according to claim 5, further comprising
a channel change determination component configured to determine whether or not another channel has been set by the channel setting component when the viewing control executed by one of the program control execution component and the channel control execution component has been disabled by the operation control component,
the operation control component being further configured to enable the viewing control executed by one of the program control execution component and the channel control execution component when the channel change determination component determines that another channel has been set.

7. The broadcast receiving device according to claim 6, further comprising
a program information storage component configured to store schedule information indicating an end time for each program; and
a program determination component configured to determine whether or not the end time has been reached for a program for which the viewing control executed by one of the program control execution component and the channel control execution component is disabled based on the schedule information when the viewing control executed by one of the program control execution component and the channel control execution component has been disabled by the operation control component,
the operation control component being further configured to enable the viewing control executed by one of the program control execution component and the channel control execution component when the program determination component determines that the end time for the program has been reached.

8. The broadcast receiving device according to claim 2, further comprising
a channel change determination component configured to determine whether or not another channel has been set by the channel setting component when the viewing control executed by one of the program control execution component and the channel control execution component has been disabled by the operation control component,
the operation control component being further configured to enable the viewing control executed by one of the program control execution component and the channel control execution component when the channel change determination component determines that another channel has been set.

9. The broadcast receiving device according to claim 2, further comprising
a program information storage component configured to store schedule information indicating an end time for each program; and
a program determination component configured to determine whether or not the end time has been reached for a program for which the viewing control executed by one of the program control execution component and the channel control execution component is disabled based on the schedule information when the viewing control executed by one of the program control execution component and the channel control execution component has been disabled by the operation control component,
the operation control component being further configured to enable the viewing control executed by one of the program control execution component and the channel control execution component when the program determination component determines that the end time for the program has been reached.

10. A broadcast receiving device for receiving a television broadcast, comprising:
a channel control storage component configured to store channel control information indicating whether or not viewing control is enabled for each receivable channel;
a channel setting component configured to receive operation input, and set a channel based on the operation input;
a channel control determination component configured to determine whether or not the viewing control is enabled for the channel set by the channel setting component based on the channel control information stored in the channel control storage component;
a channel control execution component configured to execute the viewing control for the channel set by the channel setting component when the channel control determination component determines that the viewing control is enabled for the channel set by the channel setting component;
a user determination component configured to receive individual identification information identifying a user when the channel control determination component determines that the viewing control is enabled for the channel set by the channel setting component, and determine whether or not the received individual identification information matches preset individual identification information; and
an operation control component configured to disable the viewing control executed by the channel control execution component when the user determination component determines that the received individual identification information matches the preset individual identification information.

11. A viewing control method for a broadcast receiving device for receiving a television broadcast, comprising:
providing program control information indicating whether or not viewing control is enabled for each receivable program;
receiving operation input;
setting a channel based on the operation input;
determining whether or not the viewing control is enabled for a program corresponding to the channel based on the program control information;
executing the viewing control for the program corresponding to the channel upon determining that the viewing control is enabled for the program corresponding to the channel;
receiving individual identification information identifying a user upon determining that the viewing control is enabled for the program corresponding to the channel;
determining whether or not the received individual identification information matches preset individual identification information; and
disabling the viewing control upon determining that the received individual identification information matches the preset individual identification information.
